(19) United States
(12) Patent Application Publication
(10) Pub. No.: US 2002/0171884 A1
(43) Pub. Date: Nov. 21, 2002

(54) High efficiency optical traffic monitoring and reporting

(76) Inventor: Dan Dan Yang, Los Altos, CA (US)

Correspondence Address: CASSAN MACLEAN, 80 ABERDEEN STREET, OTTAWA , ONTARIO, KLS5R5, CA

(21) Appl. No.: 09/855,600

(22) Filed: May 16, 2001

(51) Int. Cl. H04B 10/08; H04J 14/02

(52) U.S. Cl. 359/110; 359/124

(57) ABSTRACT

Methods and devices which use a tunable optical filter to only scan selected portions of spectrum of the optical carrier. By not scanning the whole spectrum, fast scanning is achieved while providing high scanning resolution by the use of the tunable optical filter. To save board space and cost, data is compared with existing data from the network at a logically remote location.

### FIELD OF THE INVENTION

The present invention relates to optical communications and, more specifically, to methods and devices for monitoring and assessing the quality of optical traffic in a network.

### BACKGROUND TO THE INVENTION

The recent growth in telecommunications, spurred by the development and spread of the Internet, has led to increasing reliance on optical networks. One problem with such networks is the gathering and processing of data related to the quality of the optical signal. This data gathering is essentially a monitoring of the optical traffic passing through an optical network node. The monitoring can determine if the optical network is functioning properly within acceptable parameters. It also provides basic information for further processing in an optical node, such as compensation, switching etc.

Currently, there are several known techniques for monitoring an optical signal which is transported by wavelength division multiplexing (WDM) systems. The first technique uses diffractive optics to determine if the required signals in an optical carrier are being transmitted at the correct wavelengths and at the correct levels. The optical carrier is received at an optical component and is passed through a diffractive optics. The multiple optical signals contained in the optical carrier are divided into their different wavelengths by the optics device. An optical detector then receives and detects these different wavelengths. While this technique is considered fast, its resolution is limited by the number of pixels in the optical detector and/or by the resolution of the optics device. For higher resolution, a densely populated optical detector, with its attendant high cost, is needed, along with a suitably high resolution of the optics. Furthermore, the technique, for proper execution, has specific requirements such as a relatively large physical distance between the diffractive optics and the optical detector. This would make the whole monitoring device a large size.

Another technique uses a tunable optical filter to detect and scan the optical carrier signal. In this technique, a tunable optical filter continuously scans the whole spectrum of the optical carrier to detect and collect data on the multiple optical signals carried by the optical carrier. While the resolution of this technique is much better than that of the above diffractive optics technique, the scanning technique is quite slow and cumbersome. Continuously scanning the spectrum covered by the carrier signal can take a relatively long time if sufficient resolution is required. The process may be speeded up by reducing the resolution, using a larger bandwidth filter for example, but the data gathered is inadequate for optical signal analysis purposes.

Another problem with the current techniques (diffractive optics or filter based) involves the onboard reference or calibration of optical signal wavelengths. Once the signal characteristic data has been gathered from the optical signals carried by the optical carrier, this signal characteristic data must be compared with ideal or reference data. The reference data can be provided by devices such as a reference cell which can give accurate wavelength readings, or a reference laser. No matter which reference method is used, they all require extra on-board hardware, and additional software for comparison. Having such reference or calibration equipment provides accurate wavelength detection but at the cost of increasing the cost by up to 30% and of increasing the board space by as much as 50%.

From the above, it is clear that there is a need for a different data gathering method that avoids the shortcomings of the techniques mentioned. The desired method would provide optical signal information accurately at a very fast speed, while still keeping the real estate small enough to be adopted easily into optical equipment chasis.

### SUMMARY OF THE INVENTION

The present invention overcomes the deficiencies of the prior art by providing methods and devices which use a tunable optical filter to only scan selected portions of spectrum of the optical carrier. By not scanning the whole spectrum, fast scanning is achieved while providing high scanning resolution by the use of the tunable optical filter. To save board space and cost, data is compared with existing data from the network at a logically remote location.

In a first embodiment, the present invention provides a method of gathering/processing data related to signal quality of multiple optical signals transmitted to a node in an optical network using an optical carrier. The method comprises receiving the optical carrier and the multiple optical signals at the node, scanning a specific wavelength band of the optical carrier for signal characteristics of a specific optical signal, the wavelength band being substantially centered around a wavelength used by the specific optical signal, and repeating the previous steps for each of the multiple optical signals.

Preferably, the scanning is accomplished by using a tunable optical filter.

In another aspect, the invention provides a method of determining signal quality of at least one optical signal transmitted to a node in an optical network using an optical carrier. The method comprises: gathering data related to signal quality for at least one optical signal, processing the data to determine signal quality parameters of the at least one optical signal, retrieving signal wavelength references from a location logically remote from said node, and comparing the signal quality parameters with the signal quality references.

A further embodiment of the invention provides a method to provide accurate wavelength information in order to automatically determine if a laser transmitter is malfunctioning. The method comprises as a first step, receiving at the node an optical carrier having multiple optical signals. The second step of the method is scanning a specific wavelength band of the optical carrier to determine an actual wavelength at which an optical signal under observation is being transmitted, the specific wavelength band being centered at a predetermined reference wavelength, the predetermined reference wavelength being a theoretical wavelength at which the optical signal under observation is supposed to be transmitted, the optical signal under observation being one of the multiple optical signals. A third step is that of comparing the actual wavelength with the reference wavelength. After this, the method goes on to storing differences between the actual wavelength and the reference wavelength. The second to the fourth steps are then repeated for each of a plurality of the multiple optical signals. Finally, the method determines if the differences stored are consistent for each of the plurality of multiple optical signals.

Another aspect of the invention provides an optical network component having a tunable optical filter. The optical component gathers optical signal data using the optical filter by the following method:

a) receiving an optical carrier and multiple optical signals;

b) scanning a specific wavelength band of said optical carrier for signal characteristics of a specific optical signal, said wavelength band being substantially centered around a wavelength used by a specific optical signal

c) repeating steps a) and b) for each of said multiple optical signals.

As part of the invention, step b) is executed using the optical filter. Also, it should be noted that the wavelength used by the specific optical signal is to be determined with respect to international telecommunications standards.

A further aspect of the invention provides computer readable media containing computer readable and executable code for controlling a portion of an optical network component. The computer readable and executable code executes a method of gathering data related to signal quality of multiple optical signals transmitted using an optical carrier to a node at an optical network. The method comprises:

a) receiving the optical carrier and said multiple optical signals at said node;

b) scanning a specific wavelength band of said optical carrier for signal characteristics of a specific optical signal, said wavelength band being substantially centered around a wavelength used by said specific optical signal, and

c) repeating steps a) and b) for each of said multiple optical signals.

Yet another aspect of the invention provides a method of self-calibration for use on an optical network node which monitors optical traffic on an optical network. The method comprises:

a) receiving at the node an optical carrier having multiple optical signals

b) retrieving a predetermined reference wavelength from a logically remote location, the predetermined reference wavelength being a theoretical wavelength at which an optical signal under observation is supposed to be transmitted, the optical signal under observation being one of the multiple optical signals;

c) determining an actual wavelength at which the optical signal under observation is being transmitted;

d) comparing the actual wavelength with the reference wavelength;

e) storing differences between the actual wavelength and the reference wavelength

f) repeating steps b) to e) for a plurality of the multiple optical signals

g) determining if a magnitude of the differences stored in step e) are uniform for each of the plurality of multiple optical signals

h) if the magnitude of the differences are uniform, adjusting subsequent wavelength measurements by a specified amount, said specified amount being determined by the magnitude of the differences.

The invention also provides for an optical network component to be used with a network node for monitoring network traffic. The component comprises a tunable optical filter which receives an optical carrier from the node and the optical carrier carries a plurality of optical signals. The component also has an optical detector which receives a filtered optical signal from the tunable optical filter, and an internal controller coupled to and controlling the filter and the detector. The controller receives an output of the detector for processing. The controller determines signal characteristics of a specific optical signal based on the output of the detector with the specific optical signal being one of the plurality of optical signals.

### BRIEF DESCRIPTION OF THE DRAWINGS

A better understanding of the invention may be obtained by reading the detailed description of the invention below, in conjunction with the following drawings, in which:

FIG. 1 is a block diagram of a generic optical network subsystem;

FIG. 2 is a waveform representing a portion of the spectrum of an optical carrier carrying multiple optical signals;

FIG. 3 is block diagram illustrating a network node with a scanning module installed;

FIG. 4 is a block diagram of a scanning module according to an embodiment of the invention;

FIG. 5 is a flowchart detailing the steps followed by the internal controller module in controlling the tunable filter to scan a scanning region;

FIG. 6 is a waveform diagram illustrating a constant difference between a waveform generated from gathered data and a waveform generated from reference data; and

FIG. 7 is a waveform diagram illustrating a possible fault in the network and how this is affects the waveform diagrams of FIG. 6.

### DETAILED DESCRIPTION

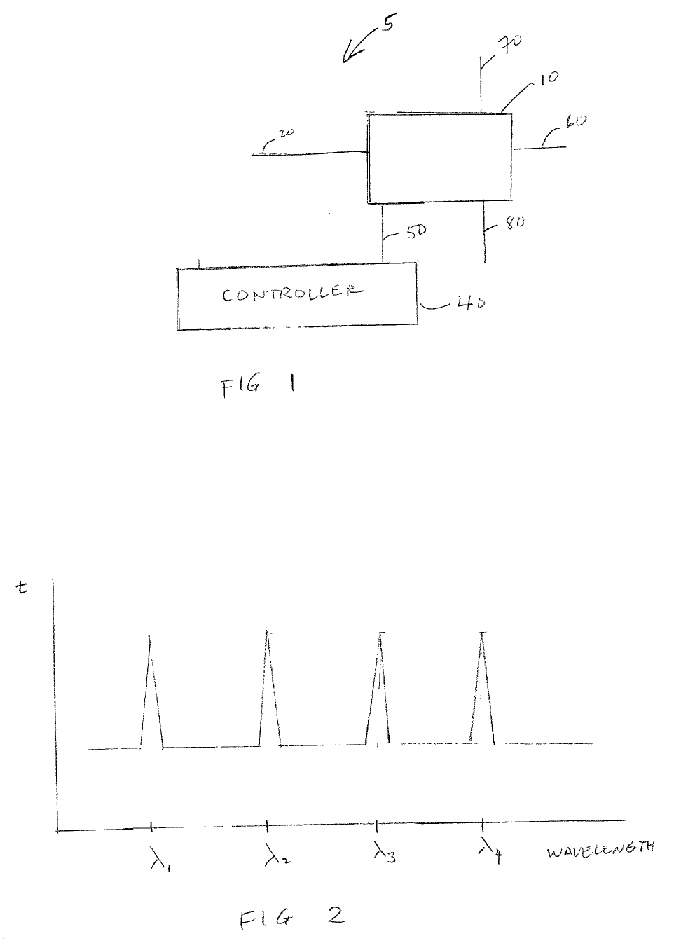

Referring to FIG. 1, a block diagram of a generic subsystem of an optical network is illustrated. An optical component 10 receives an optical carrier 20. The optical carrier 20 contains multiple optical signals encoded into the optical carrier. The optical component 10 is coupled to and controlled by a controller 40 by means of control line 50. The optical component 10 has an output 60 which results from the processing of the input optical carrier 20 by the first component 10. If the component 10 is an optical amplifier, then the output 60 is an amplified version of the input carrier 20. If the first component 10 is an attenuator, then the output 60 is an attenuated version of the input carrier 20. Input signal 70 is only needed if the first component 10 is an add/drop multiplexer and the input signal 70 is to be added to the optical carrier 20. If a signal is to be extracted from the carrier 20, then the extracted signal exits the first component 10 as secondary output 80. It should be noted that the optical component 10 is a node in an optical network.

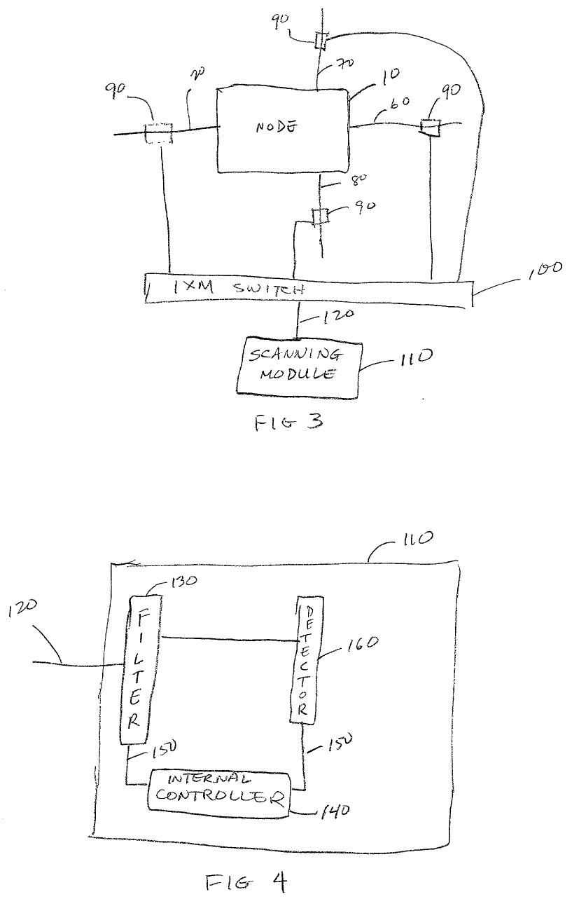

In today's optical systems, greater reliance is made on optical networks which use WDM (wavelength division multiplexing). To explain this, FIG. 2 illustrates a waveform representing a portion of the spectrum of the optical carrier 20. At specified wavelengths λ1, λ2, λ3, and λ4, optical signals 90A, 90B, 90C, and 90D are encoded. It should be noted that there are discrete and fixed gaps between the wavelengths λ1, λ2, λ3, and λ4. It should also be noted that the specified wavelengths λ1, λ2, λ3, and λ4 which carry the data transmitted are predetermined and known. These wavelengths are fixed and regulated by international standards and regulatory bodies such as the ITU (International Telecommunications Union).

Referring to FIG. 3, the first optical component 10 is illustrated coupled with a scanning mechanism. As can be seen, the inputs 20, 70 and outputs 60, 80 of component 10 (also a network node) is equipped with an optical tap 90. Each of these taps 90 are coupled to an optical switch matrix (1×m matrix) 100. The other end of the switch matrix 100 is coupled to a scanning module 110 through an optical link 120. The switch matrix 100 is well-known in the art and allows any of the taps 90 to be directly coupled to the scanning module 110.

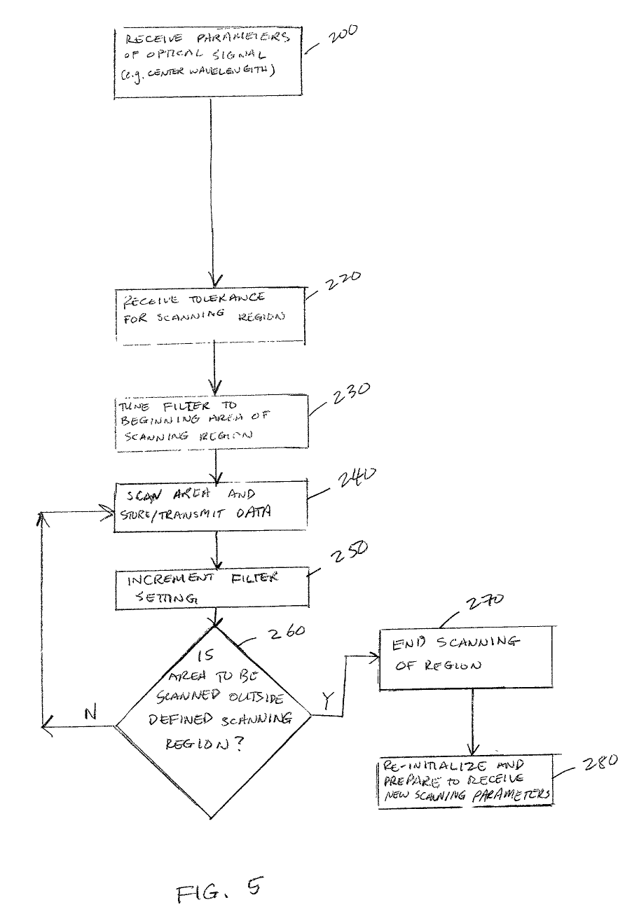

Referring to FIG. 4, a detailed block diagram of the scanning module 110 is illustrated. The carrier, from a tap 90, is received by a tunable optical filter 130. This tunable optical filter is well-known in the art and acts as a band-pass optical filter with the wavelength passband being controlled and tuned by the internal control module 140 through the internal control lines 150. The filtered signal is then received by a signal detector 160 which extracts the signal characteristic data from the signal and passes this data to the internal control module 140. It should be noted that the data extracted is data that relates to the optical signal itself and is not the data that is encoded in the optical signal. This data is then processed to determine if the optical signal is, among others, being properly sent.

The tunable filter 130 is tuned to have a passband that provides enough resolution for the signal detector to extract the necessary characteristic data. This data can be any characteristic parameter that an optical signal may have such as a signal's strength, signal-to-noise ratio (SNR), or its power. By comparing this data to reference data, the performance of the subsystem can be determined.

To further explain the function of the tunable filter, reference to FIG. 2 will be made. To increase the speed of the scanning process, only selected portions of the carrier spectrum will be scanned. Thus, if data regarding the optical signal transmitted on wavelength λ1 is required, the tunable filter will only scan the region around λ1. A tolerance setting can be programmed by the internal control module so that the tunable filter scans a specific region around λ1. As an example, if the tolerance setting is 0.15 nm then the filter will scan the wavelengths between λ1−0.15 nm and λ1+0.15 nm with λ1 being in the center of the scanned region. This tolerance allows a certain flexibility in the scanned area. If a signal is transmitted at a wavelength that is not exactly equal to the center wavelength (e.g. λ1) then the signal will still be scanned. Furthermore, because of this flexibility, the actual wavelength at which the signal is transmitted can be found.

As an example, if λ1 were 1555.75 nm (corresponding to ITU channel 27) and a tolerance setting of 0.15 nm were set, the tunable filter may have a suitable passband resolution of 0.05 nm. From the example, the region to be scanned is from λ1−0.15 nm=1555.75−0.15=1555.60 nm to λ1+0.15=1555.75+0.15=1555.90 nm. For a given resolution of 0.05 nm, the initial passband for the tunable filter will be 1555.60 nm to 1555.65 nm. This passband will be incremented as the filter scans the scanning region. The scanning will have 6 steps as given by (width of region to be scanned)/resolution=[(1555.90−1555.60)/0.05]=6 steps. Each step will generate data relating to the 0.05 nm passband being examined. For even faster scanning, a counter which tracks and controls the incrementing of the passband can increase the increment without increasing the passband width. As an example, instead of examining the passband 1555.65 nm−1555.70 nm after the initial passband, the second passband can be 1555.70 nm−1555.75 nm. By skipping every other passband, the number of steps can be halved, thereby increasing the speed of the process without losing resolution.

Once the region around λ1 has been scanned, a second scanning region can be scanned in a similar manner. However, as opposed to the known techniques, the gap between the initial region centered around λ1 and the second region centered around λ2 will not be scanned. Instead, only the region around λ2 will be scanned. This can easily be done, as the value of λ2 is known. The tunable filter will be programmed to only scan the region around λ2. The values for the center wavelengths (λ1, λ2, λ3, λ4, and others) are easily obtained, as they are specifically set.

The process followed by the internal controller module is that set out in the flowchart of FIG. 5. The process begins with the controller determining or receiving the center wavelength to be scanned (step 200). The required tolerance or the amount of region around the center wavelength which will be scanned is then set (step 220). Once this is done, the scanning is ready to being. The filter is thus directed (step 230) to the beginning of the scanning region. For the above example, this beginning of the scanning region is λ1−0.15 if the tolerance is given as 0.15 nm.

Returning to FIG. 5, the scanning then proceeds in step 240. For every piece of data gathered, the data is transmitted to the internal controller module either for processing or for further transport to the controller. The data gathered may be stored by the internal controller module for processing or for subsequent retransmission. Step 250 is that of incrementing the filter setting to scan the next portion of the scanning region. Decision 260 determines, from the incremented filter setting, whether the portion to be scanned is outside the scanning region (i.e. past the end of the scanning region). If the portion is not past the end of the scanning region, then that portion is scanned (step 240) and the loop formed by steps 240, 250, and 260 continues. If, however, the portion is past the scanning region, the scan ends (step 270) and the internal control module prepares for the next scanning region (step 280).

Once the data has been collected, this must be compared with reference data to determine whether the optical network is performing within acceptable parameters. The reference data is preferably retrieved from a logically remote location by either the internal controller module in the optical component or the controller which controls the subsystem. This means that the reference data is to be retrieved from somewhere other than within the optical component. One possible location for this data is at an optical network terminal. This retrieval can easily be done as the reference data are ideal parameters set by manufacturers of either the optical component or the optical network itself.

One use of the above process is to determine whether a laser in the network is malfunctioning and needs replacement. The optical component receiving the optical carrier can scan all or at least most of the optical signals carried by the carrier. If all the optical signals are transmitted with a uniform deviance from the center wavelength, then the transmitting laser is operating properly. As an example, again using the terminology and examples in FIG. 2, if the optical signals are supposedly being transmitted on wavelengths λ1, λ2, λ3, and λ4, then the regions around those wavelengths are to be scanned for the actual transmitting wavelength.

If, after the scanning, the actual transmission wavelengths are found to be λ1+0.5 nm, λ2+0.5 nm, λ3+0.5 nm, and λ4+0.5 nm, then there is a uniformity in the deviance from the theoretical transmission wavelength. This means that the transmitting laser is correctly functioning and that the scanning equipment must be automatically recalibrated. However, if the transmission wavelengths were found to be λ1+0.3 nm, λ2−0.7 nm, λ3+0.2 nm, and λ4−0.5 nm, then the transmitting laser is malfunctioning. The nonuniformity of the deviance shows that the transmitting laser is oscillating erratically and should therefore by serviced. At this occurrence, the optical component must send an alarm signal to the internal controller module and to the external controller that a fault seems to have occurred.

Another use of the above scanning method is to determine whether the system as a whole is functioning properly. The optical network node connected to the scanning apparatus or scanning module 110 can be equipped with multiple ports and a switching network as shown in FIG. 3. The switching network would allow the scanning module to be connected to any of the ports. Once connected to a port, the scanning module, after receiving the relevant center wavelengths, can scan the relevant scanning regions. After such scanning and storing the scanning results, a waveform of the carrier spectrum emerges. By comparing this waveform with the expected waveform of the carrier spectrum, it can easily be determined whether the node connected to the port in question is functioning properly. Processing the data collected from the scanning can be as simple as plotting the gathered data and requesting that the expected data be transmitted from a logically remote location. Once this reference data is received, it too can be plotted and a one-to-one correspondence between the two plotted data sets can be made. If they match, then the node connected to that port is functioning properly. If the two waveforms do not match, then any major discrepancies can be the basis for an alarm notification to the controller.

As an added feature to the above data gathering and data processing optical network node, the scanning and processing equipment can be self-calibrating. Once both the gathered data set and the reference data set are plotted, the differences between them should be readily apparent. If the two waveforms track each other closely, then the portion of the network accessible through the port is functioning properly. However, to ensure that any subsequent tests are accurate, the internal controller can request at least one specific data point on the reference data set waveform from the external controller for a direct comparison with its corresponding data point from the gathered data set. The difference between these two data points is determined and then the gathered data set is uniformly adjusted so that its waveform is substantially equal to the reference data set. The amount of the adjustment is ideally uniform across the gathered data set. Such an adjustment amount can be as simple as the difference between a gathered data set point and a reference data set point. Subsequent measurements can also be adjusted by the same amount to ensure accuracy.

As an example of the above method, the data set in FIG. 2 and one of the data sets above will be used. From the data set in FIG. 2 (λ1, λ2, λ3, and λ4 as the reference data set) and the data set above (λ1+0.5, λ2+0.5, λ3+0.5, and λ4+0.5 as the gathered data set), it should be clear that the measurements are off by 0.5 nm. The internal controller in the optical component can then calibrate itself by subtracting 0.5 nm from all of its subsequent measurements. By doing this, the internal controller can thus accurately track the desired waveform emanating from the port in question.

The above self-calibration method can be executed whenever the scanning module is required to examine a different port. This way, any measurements required for that port will be accurate.

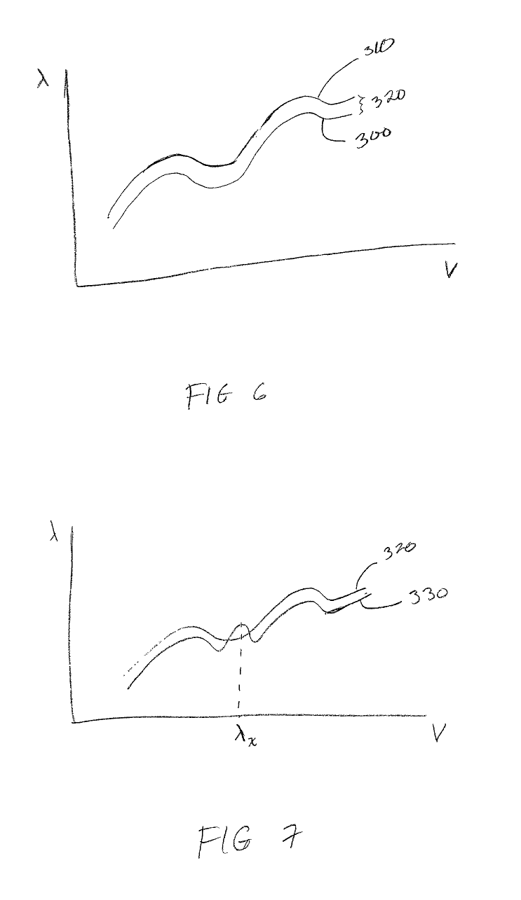

As a graphical example of the above, FIG. 6 illustrates two plotted waveforms—a first waveform 300 from data gathered by the scanning module and a second waveform 310 from reference data retrieved from a network terminal. The horizontal axis on the figure is the scanning filter control reference. In the example, the voltage is used as the control reference but other references, such as current and temperature, can be used. The vertical axis is the wavelength of the scanned signal.

From FIG. 6, it can be seen that the two waveforms are identical except for a constant vertical separation. This constant gap difference 320 can be calculated as the measured wavelength equals the wavelength reading added to a constant A. By retrieving at least one data point on waveform 300 and from its corresponding data point on waveform 310, the difference between these two data points is the constant A.

Once the constant difference is found, the scanning module can automatically calibrate itself by merely subtracting the constant A from its wavelength readings from the port waveform 310 is read from. Of course, this will only occur if the two waveforms substantially track each other with a constant difference.

Referring to FIG. 7, a graphical example of the diagnostic function of the scanning module is illustrated. FIG. 7 illustrates waveform 320, plotted from reference data. Also illustrated is waveform 330, plotted from gathered data. As can be seen, the two waveforms do not match in that there is a bulge around the area denoted by λx. The rest of the readings, as plotted on waveform 330, are at a constant difference from waveform 320. This means that the transmitter transmitting at wavelength λx is malfunctioning. The conclusion arises from the nonuniformity at λx of the difference between waveforms 320 and 330. An alarm can thus be triggered, denoting a possible malfunction of the transmitter transmitting at λx.

We claim:

1. A method of gathering data related to signal quality of multiple optical signals transmitted to a node in an optical network using an optical carrier, the method comprising:
a) receiving the optical carrier and said multiple optical signals at said node;
b) scanning a specific wavelength band of said optical carrier for signal characteristics of a specific optical signal, said wavelength band being substantially centered around a wavelength used by said specific optical signal
c) repeating steps a) and b) for each of said multiple optical signals.

2. A method as in claim 1 wherein step b) is accomplished by using a tunable optical filter.

3. A method as in claim 1 wherein said wavelength used by said specific optical signal is determined according to a predetermined standard.

4. A method of determining signal quality of at least one optical signal transmitted to a node in an optical network using an optical carrier, the method comprising:
a) gathering data related to signal quality for said at least one optical signal;
b) processing said data to determine signal quality parameters of said at least one optical signal;
c) retrieving signal quality references from a location logically remote from said node;
d) comparing said signal quality parameters with said signal quality references.

5. A method as in claim 4 wherein step a) comprises:
a1) receiving the optical carrier and said at least one optical signal at said node;
a2) scanning a specific wavelength band of said optical carrier for signal characteristics of said at least one optical signal, said wavelength band being substantially centered around a wavelength used by said at least one optical signal.

6. A method as in claim 5 wherein step a2) is accomplished using a tunable optical filter.

7. A method as in claim 4 wherein said signal quality references are retrieved from an optical network terminal.

8. A method as in claim 5 wherein said wavelength used by said at least one optical signal is determined according to a predetermined standard.

9. A method of automatically determining if a laser transmitter is malfunctioning, the method comprising:
a) receiving at a node an optical carrier having multiple optical signals;
b) scanning a specific wavelength band of the optical carrier to determine an actual wavelength at which an optical signal under observation is being transmitted, the specific wavelength band being centered at a predetermined reference wavelength, the predetermined reference wavelength being a theoretical wavelength at which the optical signal under observation is supposed to be transmitted, the optical signal under observation being one of the multiple optical signals;
c) comparing the actual wavelength with the reference wavelength;
d) storing differences between the actual wavelength and the reference wavelength
e) repeating steps b) to d) for a plurality of the multiple optical signals
f) determining if the differences stored in step d) are uniform for each of the plurality of multiple optical signals.

10. A method as in claim 9 wherein the scanning in step b) is accomplished by using a tunable optical filter.

11. A method as in claim 9 wherein, for step f), if the differences are not uniform for each of multiple optical signals, an alarm is generated.

12. An optical network component having a tunable optical filter, the optical component gathering optical signal data using the optical filter by the following method:
a) receiving an optical carrier and multiple optical signals;
b) scanning a specific wavelength band of said optical carrier for signal characteristics of a specific optical signal, said wavelength band being substantially centered around a wavelength used by a specific optical signal
c) repeating steps a) and b) for each of said multiple optical signals wherein step b) is executed using the optical filter.

13. An optical network component as claimed in claim 12 wherein the component performs at least one other function chosen from the group comprising:
optical signal amplification
optical signal attenuation
optical signal processing
addition of optical signals
deletion of at least one optical signal from the optical carrier
retransmission of the optical carrier in the manner of an optical repeater.

14. Computer readable media containing computer readable and executable code for controlling a portion of an optical network component, said computer readable and executable code executing a a method of gathering data related to signal quality of multiple optical signals transmitted using an optical carrier to a node at an optical network, the method comprising:
a) receiving the optical carrier and said multiple optical signals at said node;
b) scanning a specific wavelength band of said optical carrier for signal characteristics of a specific optical signal, said wavelength band being substantially centered around a wavelength used by said specific optical signal
c) repeating steps a) and b) for each of said multiple optical signals.

15. Computer readable media as claimed in claim 14 wherein step b) is accomplished by using a tunable optical filter.

16. A method of self-calibration for use on an optical network node which monitors optical traffic on an optical network, the method comprising:
a) receiving at the node an optical carrier having multiple optical signals
b) retrieving a predetermined reference wavelength from a logically remote location, the predetermined reference wavelength being a theoretical wavelength at which an optical signal under observation is supposed to be transmitted, the optical signal under observation being one of the multiple optical signals;
c) determining an actual wavelength at which the optical signal under observation is being transmitted;
d) comparing the actual wavelength with the reference wavelength;
e) storing differences between the actual wavelength and the reference wavelength
f) repeating steps b) to e) for a plurality of the multiple optical signals
g) determining if a magnitude of the differences stored in step e) are uniform for each of the plurality of multiple optical signals
h) if the magnitude of the differences are uniform, adjusting subsequent wavelength measurements by a specified amount, said specified amount being determined by the magnitude of the differences.

17. A method as in claim 14 wherein step c) is accomplished using a tunable optical filter to scan a specific wavelength band of the optical carrier, said specific wavelength band being centered at the predetermined reference wavelength.

18. An optical network component to be used with a network node for monitoring network traffic, said component comprising:
a tunable optical filter receiving an optical carrier from said node, said optical carrier carrying a plurality of optical signals;
an optical detector receiving a filtered optical signal from said tunable optical filter;
an internal controller coupled to and controlling said filter and said detector, said controller receiving an output of said detector for processing; wherein
said controller determines signal characteristics of a specific optical signal based on said output of said detector, said specific optical signal being one of said plurality of optical signals.

19. An optical component as claimed in claim 17 wherein said filter receives said optical carrier through a network optical switch, said switch being coupled to at least one optical tap on an input or an output line of said node such that said component can be coupled to any input or output line of said node.
